(19) United States
(12) Patent Application Publication
(10) Pub. No.: US 2018/0300552 A1
(43) Pub. Date: Oct. 18, 2018

(54) Differential Tracking for Panoramic Images

(71) Applicant: Structionsite Inc., San Francisco, CA (US)

(72) Inventor: Philip Garcia Lorenzo, Sacramento, CA (US)

(73) Assignee: Structionsite Inc., San Francisco, CA (US)

(21) Appl. No.: 16/018,138

(22) Filed: Jun. 26, 2018

Related U.S. Application Data
(60) Provisional application No. 62/525,198, filed on Jun. 27, 2017.

(51) Int. Cl. G06K 9/00; H04N 5/232

(52) U.S. Cl. CPC G06K 9/00671; G06K 9/00765; G06K 9/00637; H04N 5/23238

(57) ABSTRACT

A method is provided. The method includes one or more of creating, with a first 360 degree image capture device, a video while moving along a path within a building at a first time, extracting a plurality of first 360 degree photos from the video, deriving one or more of locations and orientations within the building for each of the plurality of first 360 degree photos, obtaining a plurality of second 360 degree photos at one or more positions in proximity to one or more points along the path at a second time later than the first time, and identifying differences between the first plurality of 360 degree photos and the second plurality of 360 degree photos. The plurality of second 360 degree photos has one or more common locations and orientations within the building as the plurality of first 360 degree photos.

### CROSS REFERENCE TO RELATED APPLICATION(S)

This application claims priority to earlier filed provisional application no. 62/525,198 filed Jun. 27, 2017 and entitled “PANORAMIC VIRTUAL TOUR METHOD”, the entire contents of which are hereby incorporated by reference.

### FIELD

The present invention is directed to methods and systems for panoramic imaging for building sites, and more specifically differential tracking for panoramic images of building environments.

### BACKGROUND

360 degree images, also known as immersive images or spherical images, are images where a view in every direction is recorded at the same time, shot using an omnidirectional camera or a collection of cameras. During photo viewing on normal flat displays, the viewer has control of the viewing direction and field of view. It can also be played on a displays or projectors arranged in a cylinder or some part of a sphere. 360 degree photos are typically recorded using either a special rig of multiple cameras, or using a dedicated camera that contains multiple camera lenses embedded into the device, and filming overlapping angles simultaneously. Through a method known as photo stitching, this separate footage is merged into one spherical photographic piece, and the color and contrast of each shot is calibrated to be consistent with the others. This process is done either by the camera itself, or using specialized photo editing software that can analyze common visuals and audio to synchronize and link the different camera feeds together. Generally, the only area that cannot be viewed is the view toward the camera support.

360 degree images are typically formatted in an equirectangular projection. There have also been handheld dual lens cameras such as Ricoh Theta V, Samsung Gear 360, Garmin VIRB 360, and the Kogeto Dot 360—a panoramic camera lens accessory developed for the iPhones, and Samsung Galaxy models.

360 degree images are typically viewed via personal computers, mobile devices such as smartphones, or dedicated head-mounted displays. Users may pan around the video by clicking and dragging. On smartphones, internal sensors such as gyroscopes may also be used to pan the video based on the orientation of the mobile device. Taking advantage of this behavior, stereoscope-style enclosures for smartphones (such as Google Cardboard viewers and the Samsung Gear VR) can be used to view 360 degree images in an immersive format similar to virtual reality. The phone display is viewed through lenses contained within the enclosure, as opposed to virtual reality headsets that contain their own dedicated displays.

### SUMMARY

The present invention is directed to solving disadvantages of the prior art. In accordance with embodiments of the present invention, a method is provided. The method includes one or more of creating, with a first 360 degree image capture device, a video while moving along a path within a building at a first time, extracting a plurality of first 360 degree photos from the video, deriving one or more of locations and orientations within the building for each of the plurality of first 360 degree photos, obtaining a plurality of second 360 degree photos at one or more positions in proximity to one or more points along the path at a second time later than the first time, and identifying differences between the first plurality of 360 degree photos and the second plurality of 360 degree photos. The plurality of second 360 degree photos has one or more common locations and orientations within the building as the plurality of first 360 degree photos.

In accordance with another embodiment of the present invention, a system is provided. The system includes one or more of a first 360 degree image capture device and an image processing device. The first 360 degree image capture device is configured to create a video while the first 360 degree image capture device moves along a path within a building at a first time. The image processing device includes a processor and a memory coupled to the processor. The memory includes a 360 degree photo viewer application. The processor is configured to extract a plurality of first 360 degree photos from the video, derive one or more of locations and orientations within the building for each of the plurality of first 360 degree photos, obtain a plurality of second 360 degree photos at one or more positions in proximity to one or more points along the path-at a second time later than the first time, display one or more first and second 360 degree photos in the 360 degree photo viewer application, the one or more second 360 degree photos corresponds to one or more first 360 degree photos taken from common locations within the building. The plurality of second 360 degree photos has one or more common locations and orientations within the building as the plurality of first 360 degree photos.

In accordance with yet another embodiment of the present invention, a non-transitory computer readable storage medium is provided. The non-transitory computer readable storage medium configured to store instructions that when executed cause a processor to perform one or more of creating, with a first 360 degree image capture device, a video while moving along a path within a building at a first time, extracting a plurality of first 360 degree photos from the video, deriving one or more of locations and orientations within the building for each of the plurality of first 360 degree photos, obtaining a plurality of second 360 degree photos at one or more positions in proximity to one or more points along the path at a second time later than the first time, and identifying differences between the first plurality of 360 degree photos and the second plurality of 360 degree photos. The plurality of second 360 degree photos has one or more common locations and orientations within the building as the plurality of first 360 degree photos.

One advantage of the present application is that it provides a method and system for tracking progress at a building construction site using 360 degree photos. This may allow a construction expert at a remote site to extract needed 360 degree photos, perform a comparison with newer 360 degree photos, and identify differences between older and newer 360 degree photos of the same locations.

One advantage of the present application is that it provides a method for efficiently obtaining a series of panoramic or 360 degree photos from a single building walkthrough. This may allow an untrained individual to perform the walkthrough without knowing construction details or understanding progress of building construction.

Another advantage of the present application is that it allows use of non-annotated, annotated at one or more coordinates, or generally annotated (i.e. not at a specific coordinate) 360 degree photos. Each of these types of 360 degree photos may be compared to newer photos at the same locations, and annotation may provide more specific items to review.

Yet another advantage of the present application is it provides the ability to track installation of major components for purposes of payments or billings to a contractor for work performed, based on the differences between first and second 360 degree photos.

Yet another advantage of the present application is it provides the ability to track historical progress in order to determine trends in installation velocity to predict where delays may occur before they occur.

Yet another advantage of the present application is it provides the ability to identify when a construction phase is completed, which may let a contractor on a team know and prepare for a later phase that's coming next.

Additional features and advantages of embodiments of the present invention will become more readily apparent from the following description, particularly when taken together with the accompanying drawings. This overview is provided to introduce a selection of concepts in a simplified form that are further described below in the detailed description. It may be understood that this overview is not intended to identify key features or essential features of the claimed subject matter, nor is it intended to be used to limit the scope of the claimed subject matter.

### BRIEF DESCRIPTION OF THE DRAWINGS

FIG. 1 is a diagram illustrating a 360 degree image capture system in accordance with embodiments of the present invention.

FIG. 2 is a block diagram illustrating an image processing device in accordance with embodiments of the present invention.

FIG. 3 is a diagram illustrating image processing device metadata in accordance with embodiments of the present invention.

FIG. 4A is a diagram illustrating a first 360 degree video capture in accordance with embodiments of the present invention.

FIG. 4B is a diagram illustrating a second 360 degree photo capture in accordance with embodiments of the present invention.

FIG. 5 is a diagram illustrating extracted first and second 360 degree photos in accordance with embodiments of the present invention.

FIG. 6 is a diagram illustrating 360 degree camera orientation in accordance with embodiments of the present invention.

FIG. 7A is a diagram illustrating a first 360 degree photo without annotation in accordance with embodiments of the present invention.

FIG. 7B is a diagram illustrating an annotated first 360 degree photo in accordance with embodiments of the present invention.

FIG. 8 is a diagram illustrating a second 360 degree photo in accordance with embodiments of the present invention.

FIG. 9A is a flowchart illustrating a panoramic image difference review process in accordance with a first embodiment of the present invention.

FIG. 9B is a flowchart illustrating a panoramic image difference review process in accordance with a second embodiment of the present invention.

### DETAILED DESCRIPTION

The present invention utilizes various technologies to allow for the creation of comparative 360 degree photos of building locations. For example, because of the unique nature of buildings undergoing active construction, the physical appearance of a building may change on a frequent basis (i.e. daily, weekly, monthly). As construction progresses, construction problems may be quickly noted and addressed. This allows construction projects to be kept on schedule, thus maintaining project cost goals. Generally, the later problems are identified and addressed, the more expensive the project becomes. This may be due to impact to following scheduled project phases or more elaborate or expensive remedies.

Digital cameras capable of capturing 360 degree panoramic photos and videos are emerging into the market as dozens of manufacturers emerge with low cost and portable solutions with software that makes it very easy to use by non-technical users. One significant use case for the technology is the generation of “virtual tours”, which allows a person to utilize a mobile or web platform to visually access a physical area, such as a house; this is done by attaching 360 photos at various locations on a map. This technology is in widespread use (e.g. Google STREETVIEW), but the software and hardware workflows to achieve the creation of such tours has been restricted to only experts in the technology.

The processes of the present application advantageously allows remote review of 360 degree building photographs in order to monitor building construction progress, identify problems during construction, annotate photographs to either describe the problem or propose a solution, and create a visual record of construction at key locations within a building construction site.

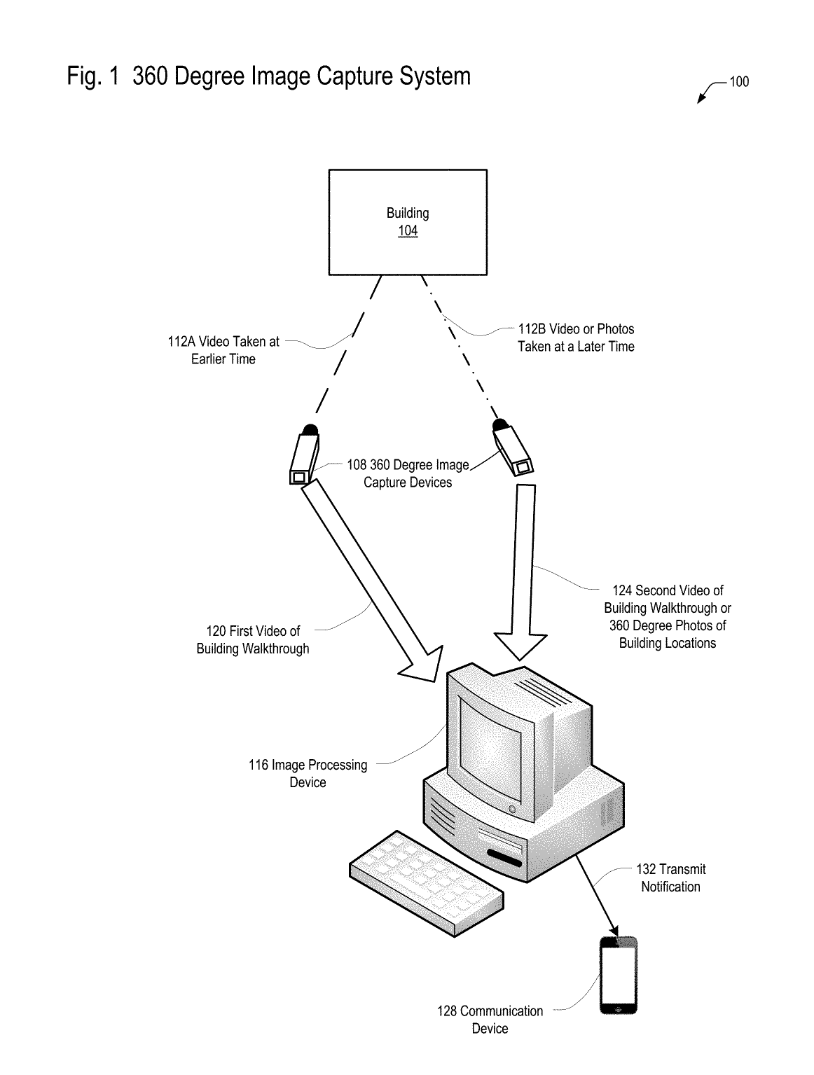

Referring now to FIG. 1, a diagram illustrating a 360 degree image capture system 100 in accordance with embodiments of the present invention is shown. FIG. 1 illustrates key components of the image capture system 100 including a building 104, one or more 360 degree image capture devices 108, and one or more image processing devices 116.

Building 104 may include any type of building, including residential and commercial structures. Building 104 may include either single or multiple story buildings, and in the preferred embodiment is a construction site. A construction site may include a building 104 in a state of assembly or construction, various types, quantities, and locations of building materials, tools, construction refuse or debris, and so forth. Construction workers or other personnel may or may not be present.

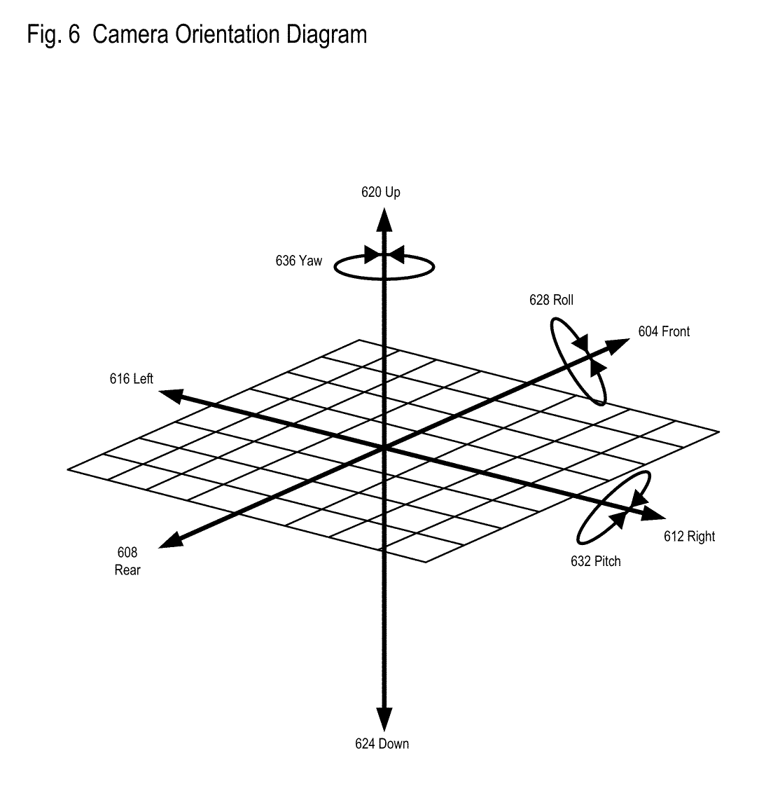

The 360 degree image capture system 100 includes one or more 360 degree image capture devices 108. In one embodiment, the 360 degree image capture device 108 is a 360 degree video camera. In another embodiment, the 360 degree image capture device 108 is a 360 degree photo camera. In another embodiment, the 360 degree image capture device 108 is a 360 degree laser scanner with photo export capability. One of the 360 degree image capture devices 108 captures a video taken at an earlier time 112A at the building 104. In one embodiment, the 360 degree video 112A is stored as a file in a memory device of the 360 degree image capture device 108, such as an SD Card or USB memory. The file may then be transferred to an image processing device 116 as a first video of the building walkthrough 120. In another embodiment, the 360 degree image capture device 108 includes a wired or wireless interface that directly or indirectly transfers the captured 360 degree video 112A as the first video of a building walkthrough 120 to the image processing device 116. In some embodiments, the first video 120 may include a single image or multiple images, and may be captured at different positions and/or with different orientations, zoom levels, or other viewing properties. Although the building 104 is represented throughout the drawings herein as a non-panoramic image for simplicity and ease of understanding, it should be understood that all captured 360 degree camera videos or photos 112, 120, 124 are true 360 -degree images with image content at all 360 degrees around the 360 degree image capture device position (i.e. all 360 degrees of yaw 636 as shown in FIG. 6).

The image processing device 116 receives and displays 360 degree captured video or photo images from 360 degree image capture devices 108. In one embodiment, the image processing device 116 is a conventional desktop, server, or mobile computer. In another embodiment, the image processing device 116 is a video workstation with one or more advanced video processing features. In another embodiment, the image processing device 116 represents one or more cloud-based computers and may process images and data as described herein in a distributed environment. In another embodiment, the image processing device 116 may represent multiple computing devices at the same or remote locations. In another embodiment, the image processing device 116 may be located in proximity to either the building 104 or 360 degree image capture devices 108, or remote to one or both.

After the video is taken (captured) at the earlier time 112A, either a second video 112B or 360 degree photos 112B are taken at a later time than video 112A. Either the same 360 degree image capture device 108 or a different 360 degree image capture device 108 may be used to record the video or photos 112B, compared to video 112A. The 360 degree image capture device 108 then transfers the second video of building walkthrough or 360 degree photos of building locations 124 to the image processing device 116 either directly/indirectly or after first storing the video or photos 124.

Once the image processing device 116 has received both the first video of the building walkthrough 120 and the second video or photos 124, the received images are compared in order to identify differences between the first video of the building walkthrough 120 and the second video or photos 124. Various aspects of the difference comparison are described herein. Finally, in some embodiments, a notification 132 may be transmitted to one or more communication devices 128. In one embodiment, the transmitted notification 132 includes results of the image comparison. In one embodiment, the transmitted notification 132 includes required actions to be takes as a result of the image comparison. In one embodiment, the transmitted notification 132 includes an existing or modified construction schedule. In another embodiment, the transmitted notification 132 includes one or more of the first video of building walkthrough 120 or the second video or photos 124. In yet another embodiment, the transmitted notification 132 may include any other images, including annotated images 512. The communication device 128 may include any of the various devices discussed with reference to the image processing device 116, and also including any other type of computing device including handheld devices, wearable devices, Internet of Things (IoT) devices, or embedded devices.

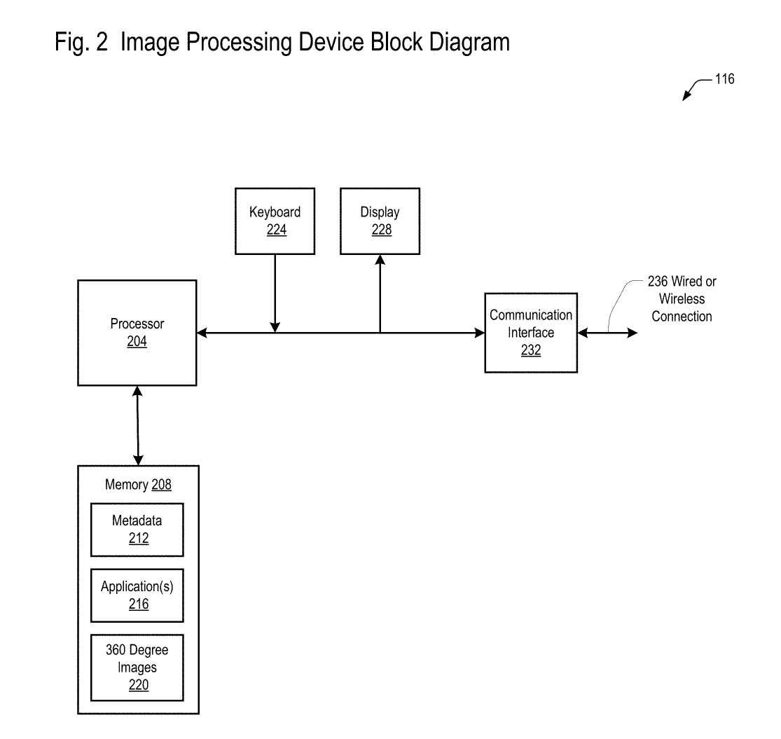

Referring now to FIG. 2, a block diagram illustrating an image processing device 116 in accordance with embodiments of the present invention is shown. The image processing device 116 may be a portable computer, and may be any type of computing device including a smart phone, a tablet, a pad computer, a laptop computer, a notebook computer, a wearable computer such as a watch, or any other type of computer as previously discussed with respect to FIG. 1.

The image processing device 116 may include one or more processors 204, which run an operating system and applications 216, and control operation of the image processing device 116. The processor 204 may include any type of processor known in the art, including embedded CPUs, RISC CPUs, Intel or Apple-compatible CPUs, and may include any combination of hardware and software. Processor 204 may include several devices including field-programmable gate arrays (FPGAs), memory controllers, North Bridge devices, and/or South Bridge devices. Although in most embodiments, processor 204 fetches application 216 program instructions and metadata 212 from memory 208, it should be understood that processor 204 and applications 216 may be configured in any allowable hardware/software configuration, including pure hardware configurations implemented in ASIC or FPGA forms.

The image processing device 116 includes a display 228, which may include control and non-control areas. In some embodiments, controls may be “soft controls”, and not necessarily hardware controls or buttons on the image processing device 116. In other embodiments, controls may be all hardware controls or buttons or a mix of “soft controls” and hardware controls. Controls may include a keyboard 224, or a keyboard 224 may be separate from the display 228. The display 228 displays any and all combinations of videos, snapshots (i.e. photos), drawings, text, icons, and bitmaps.

In some embodiments, the display 228 may be a touch screen whereby controls may be activated by a finger touch or touching with a stylus or pen. One or more applications 216 or an operating system of the image processing device 116 may identify when the display 228 has been tapped and a finger, a stylus or a pointing device has drawn on the display 228 or has made a selection on the display 228 and may differentiate between tapping the display 228 and drawing on the display 228. In some embodiments, the image processing device 116 does not itself include a display 228, but is able to interface with a separate display through various means known in the art.

Image processing device 116 includes a memory 208, which may include one or both of volatile and nonvolatile memory types. In some embodiments, the memory 208 includes firmware which includes program instructions that processor 204 fetches and executes, including program instructions for the processes disclosed herein. Examples of non-volatile memory 208 may include, but are not limited to, flash memory, SD, Erasable Programmable Read Only Memory (EPROM), Electrically Erasable Programmable Read Only Memory (EEPROM), hard disks, and Non-Volatile Read-Only Memory (NOVRAM). Volatile memory 808 stores various data structures and user data. Examples of volatile memory 208 may include, but are not limited to, Static Random Access Memory (SRAM), Dual Data Rate Random Access Memory (DDR RAM), Dual Data Rate 2 Random Access Memory (DDR2 RAM), Dual Data Rate 3 Random Access Memory (DDR3 RAM), Zero Capacitor Random Access Memory (Z-RAM), Twin-Transistor Random Access Memory (TTRAM), Asynchronous Random Access Memory (A-RAM), ETA Random Access Memory (ETA RAM), and other forms of temporary memory.

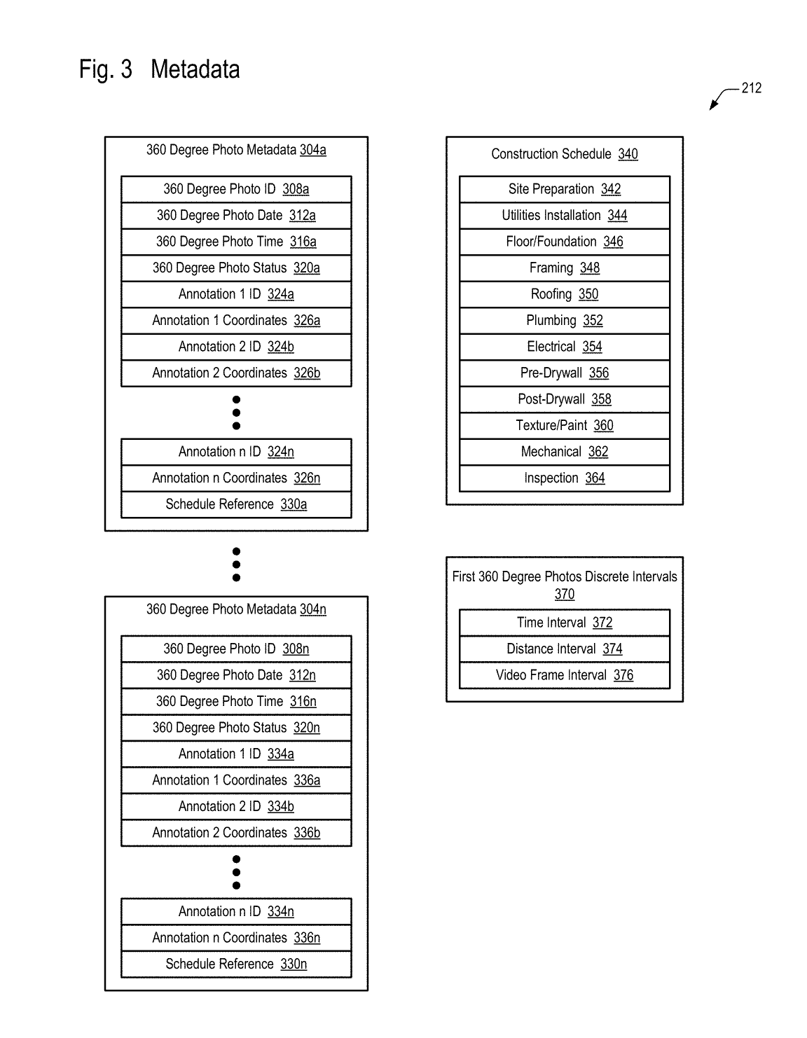

The memory 208 may store any combination of metadata 212, one or more applications 216, and 360 degree images 220. 360 degree images 220 includes videos and 360 degree photos. The metadata 212 is described in more detail with respect to FIG. 3. Metadata 212 may include various data structures in support of the operating system and applications 216.

In addition to metadata 212, memory 208 may also include one or more video & audio player application(s) including one or more 360 degree photo viewer applications 216 and one or more photogrammetry applications 216. The video & audio player application(s) 216 may play back the first video of building walkthrough 120, the second video of building walkthrough or 360 degree photos of building locations 124, annotated or non-annotated 360 degree images, or audio, and allows the visual comparisons at earlier and later times to be made. Photogrammetry applications 216 may be used to determine object positions and/or orientations within 360 degree photos. Other applications 216 may be present within memory 208 that determine construction phases of photos 508, 512, 516 and provide notification or take actions based on determined phases and construction schedules 340.

Communication interface 232 is any wired or wireless interface 236 able to connect to networks or clouds, including the internet in order to transmit and receive the first video of building walkthrough 120, the second video of building walkthrough 124, 360 degree photos of building locations, or notifications 132. In some embodiments, the image processing device 116 may include a speaker (not shown) to playback annotated audio messages, such as to provide a description of a difference between first and second 360 degree photos.

Referring now to FIG. 3, a diagram illustrating image processing device metadata 212 in accordance with embodiments of the present invention is shown. Metadata 212 includes various data structures and parameters that may be used by processes and devices of the present application to provide useful information related to building locations and construction projects. Items shown and described with reference to FIG. 3 are in some cases exemplary, and it should be understood that metadata 212 may include many other parameters and data items to support specific embodiments.

Each 360 degree video or photo may have associated metadata 304, which may be embedded as a separate layer within data of 360 degree video or photos. FIG. 3 illustrates 360 degree photo metadata 304 for n 360 degree photos, identified as 360 degree photo metadata 304a for photo A through 360 degree photo metadata 304n for photo N. Each photo A through N may have any of the following metadata items or parameters described herein.

360 degree photo metadata 304 may include a 360 degree photo ID or identifier 308, identified as 360 degree photo ID 308a through 360 degree photo ID 308n. This ID 308 uniquely differentiates each 360 degree photo (whether first or second 360 degree photos) from each other. In some embodiments, a transmit notification 132 may reference a given 360 degree photo ID 308 rather than providing a 360 degree photo or video. This may save significant time and communication bandwidth since a 360 degree photo ID 308 may be a small number of bits or bytes in size compared to many kilobytes or megabytes for 360 degree photos or videos.

360 degree photo metadata 304 may include a 360 degree photo date 312, identified as 360 degree photo date 312a through 360 degree photo date 312n. The 360 degree photo date 312 represents the date when a first or second 360 degree photo was taken, and may be useful to identify the time between when a first 360 degree photo was taken and the time when a second 360 degree photo was taken. Such a time difference may be useful when reviewing construction progress against a construction schedule 340.

360 degree photo metadata 304 may include a 360 degree photo time 316, identified as 360 degree photo time 316a through 360 degree photo time 316n. The 360 degree photo time 316 represents the time when a first or second 360 degree photo was taken, and may be useful to identify the time between when a first 360 degree photo was taken and the time when a second 360 degree photo was taken. Such a time difference may also be useful when reviewing construction progress against a construction schedule 340.

360 degree photo metadata 304 may include a 360 degree photo status 320, identified as 360 degree photo status 320a through 360 degree photo status 320n. The 360 degree photo status 320 represents any such descriptive information about a corresponding first or second 360 degree photo. The status may include a construction phase within the construction schedule 340, a sub-phase within a construction phase, a description of the part of the building 104 where the corresponding first or second 360 degree photo was taken, a purpose of taking the first or second 360 degree photo, or any other form of status.

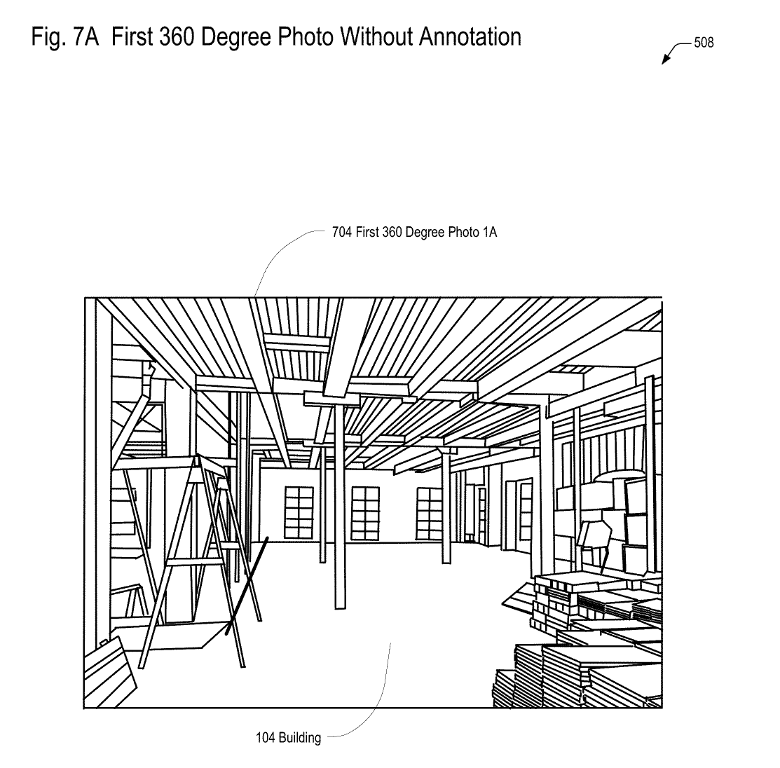

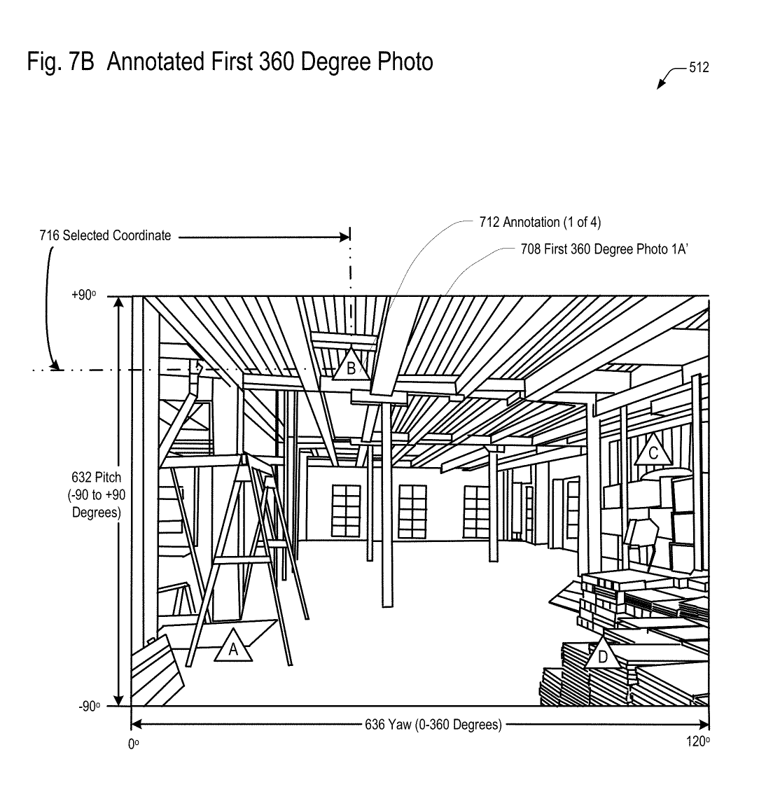

360 degree photo metadata 304 may include one or more annotation items, shown as annotation items 324-326 for 360 degree photo metadata 304a through annotation items 334-336 for 360 degree photo metadata 304n. Annotation is any form, combination, and quantity of text, symbols, or audio associated with a 360 degree photo. Annotation specifies one or more of an action, a construction state, a construction error, a date, a time, or a reminder, and each such annotation may be different in content and form from other annotations. Annotations may either be coordinate-specific or general (i.e. having no associated coordinate), and coordinate-specific annotations are described in more detail with reference to FIG. 7B. Although 360 degree photo metadata 304 includes annotation coordinates 326a -n for 360 degree photo metadata 304a and annotation coordinates 336a -n for 360 degree photo metadata 304n, it should be assumed that such coordinates may be either zero, a null value, or a predetermined value for annotation items that are general in nature and not coordinate-specific. Otherwise, the annotation coordinates 326/336 include appropriate coordinates such as pitch 632 or yaw 636 values within the corresponding first or second 360 degree photo.

Finally, 360 degree photo metadata 304 may include a schedule reference 330, identified a schedule reference 330a for 360 degree photo metadata 304a through schedule reference 330n for 360 degree photo metadata 304n. Schedule references 330 identifies either a construction phase or sub-phase of the building 104, and may provide complementary information to the 360 degree photo status 320.

Metadata 212 may also include a construction schedule 340 for the building 104. In one embodiment, there is one construction schedule 340 for the entire building 340. In another embodiment, there is one construction schedule 340 for each floor or differentiable area within the building 104. Construction schedule 340 may include any combination of dates/times, subcontractor information, deadlines, penalties, materials, and schedule dependencies. Construction schedule 340 in most embodiments is organized by construction phase, and the construction phases may be specific to the type and complexity of the overall construction. FIG. 3 shows the following exemplary construction phases for a common building 104: site preparation 342, utility installation 344, floor/foundation 346, framing 348, roofing 350, plumbing 352, electrical 354, pre-drywall 356, post-drywall 358, texture/paint 360, mechanical 362, and inspection 364. The construction schedule 340 may be consulted frequently during building 104 construction and when comparing first and second 360 degree photos.

Metadata 212 may also include stored parameters that specify discrete intervals 370 between first 360 degree photos. In one embodiment, a stored time interval 372 specifies the time delay between each first 360 degree photo, for example 10 seconds. In another embodiment, a stored distance interval 374 specifies either a straight-line distance or a walking path distance between each first 360 degree photo, for example 50 feet. In yet another embodiment, a video frame interval 376 specifies a number of video frames of the first video of building walkthrough 120 between each first 360 degree photo extracted from the video.

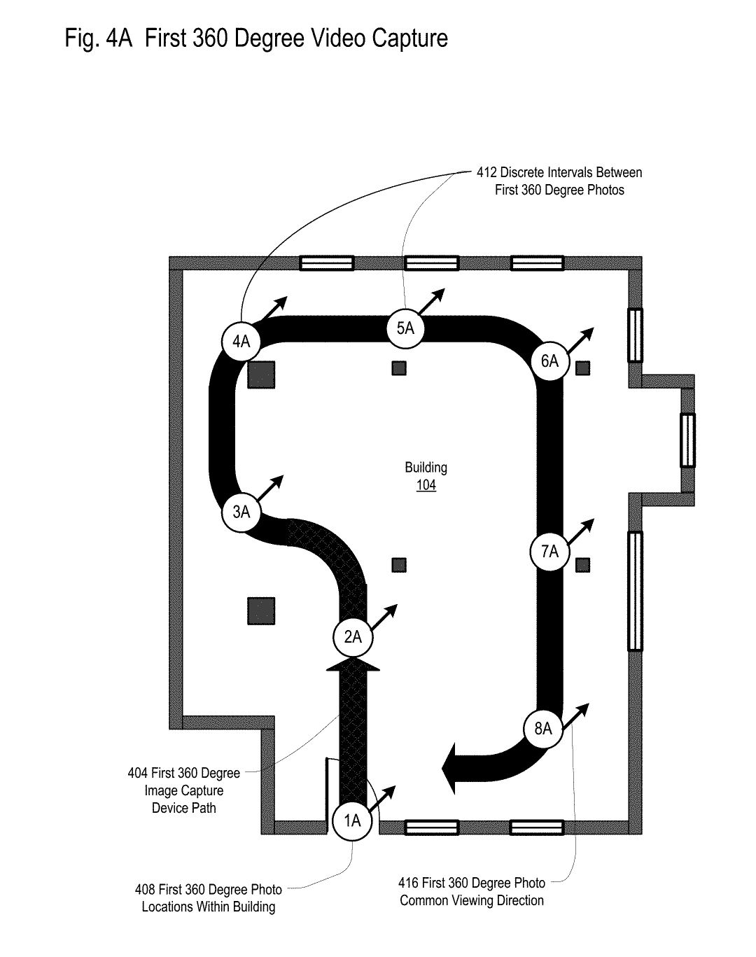

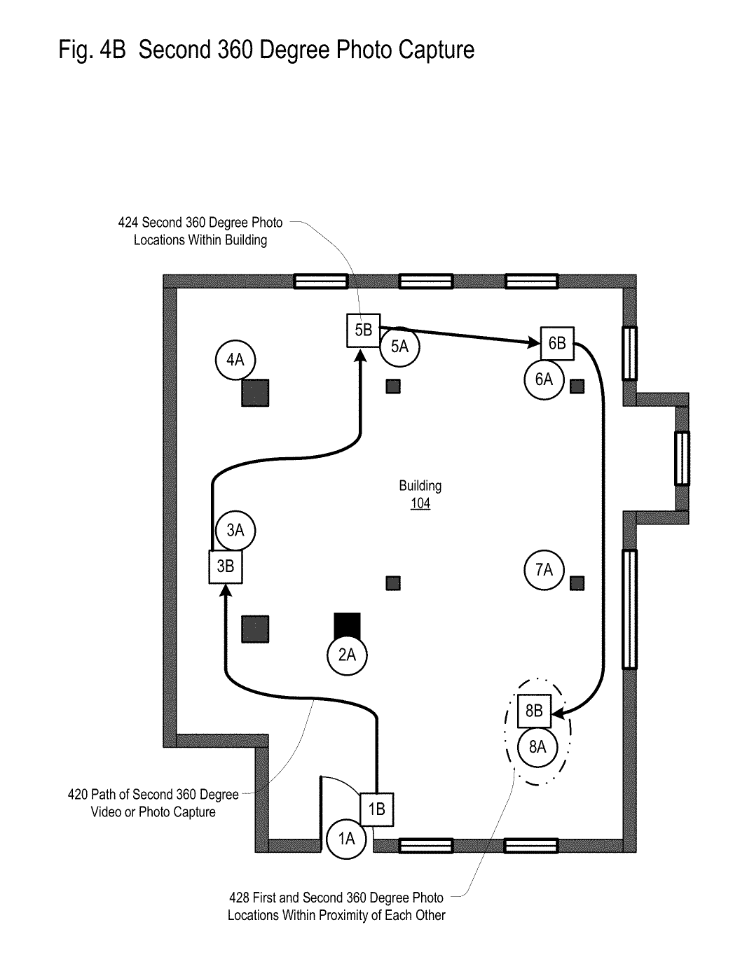

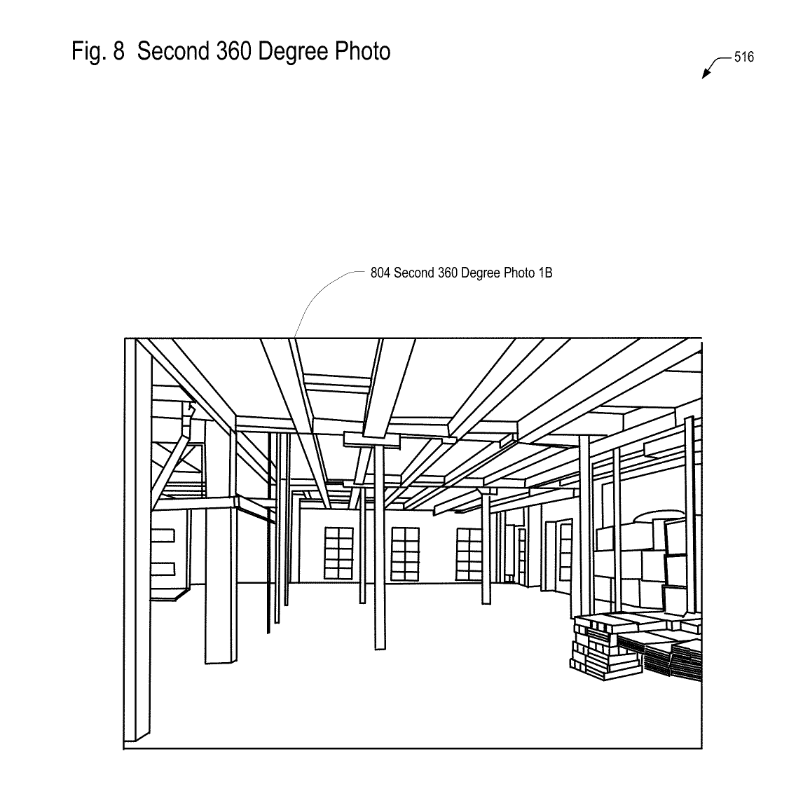

Referring now to FIG. 4A, a diagram illustrating a first 360 degree video capture in accordance with embodiments of the present invention is shown. FIG. 4A illustrates an exemplary building 104 floor plan showing a generalized door, windows, and various supporting columns. The view from the doorway corresponds approximately to the building views shown in FIGS. 7A, 7B, and 8. FIG. 4A shows a first 360 degree image capture device path 404. In one embodiment, a person or vehicle carrying a first 360 degree image capture device 108 moves along a path 404 through the building 104. The path shown 404 traverses various interior locations on a floor of the building. It should be understood the path 404 may include any combinations of interior locations, exterior locations, and floors of the building 104. The vehicle may include a drone, a robot, a radio-controlled vehicle, a self-propelled cart, a pushed/pulled cart, or any other form of conveyance. In one embodiment, a vehicle may be controlled by a user of the image processing system 116, so that no local personnel may be required at the building 104. The path 404 may be specified in advance or performed by the person or vehicle either autonomously or according to a set of criteria. Each path 404 has a defined starting position and ending position, and both may be different or the same. FIG. 4A combines both the initial video capture path/walkthrough of the building 104 as well as the initial processing of first 360 degree photos from the first video 112A by the image processing system 116.

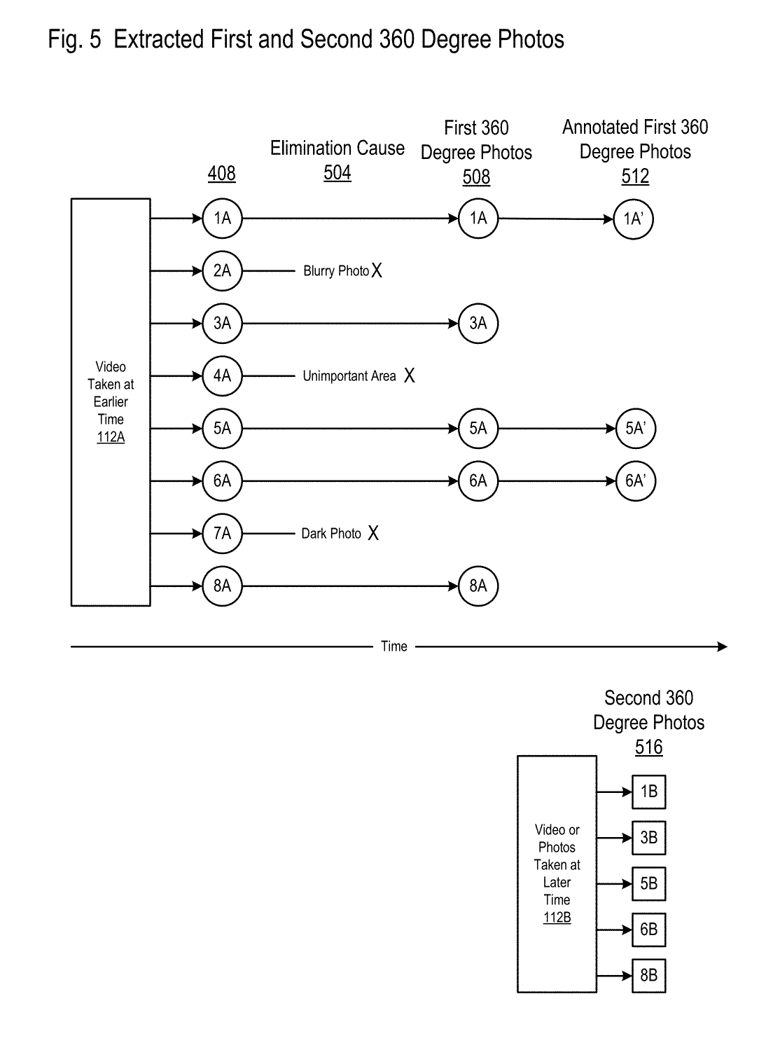

Beginning at the starting position (at the doorway in the illustrated example), the person or vehicle starts recording the video. The 360 degree image capture device 108 captures the video taken at the earlier time 112A while proceeding along the path 404. Although later, after the video taken at the earlier time 112A has been transferred to the image processing device 116, first 360 degree photo locations within the building 408 are determined, at the time of the first video walkthrough of the building those locations 408 are generally not known. These locations are identified as locations “1A” through “8A” in FIG. 4A. Therefore, by the end of the first video walkthrough, only the video itself 112A is available. The photo extraction steps from the video 112A are discussed in more detail with respect to FIG. 5. In one embodiment, the 360 degree image capture device 108 has the ability to annotate the first 360 degree video 112A, and transfer an annotated first 360 degree video 120 to the image processing system 116. In another embodiment, the image processing system 116 adds annotation to the first video of building walkthrough 120.

Of note in FIG. 4A are the discrete intervals between first 360 degree photos 412. For example, in one embodiment, a distance interval 374 may specify a first 360 degree photo be created from the video taken at the earlier time 112A every 25 feet along the path. Of second note in FIG. 4A is determining a first 360 degree video common viewing direction 416 (i.e. orientation), which is shown as generally toward the “upper right” in FIG. 4A, which may correspond to a given azimuth at building location, such as “due North”. Either a user of the image processing device 116 or photogrammetry software 216 may determine the viewing direction/orientation. Once the end of the path 404 is reached (e.g. approaching the doorway as shown by the arrow), the recording is stopped by the 360 degree image capture device 108 and the video taken at the earlier time 112A is transferred to the image processing device 116.

Referring now to FIG. 4B, a diagram illustrating a second 360 degree photo capture in accordance with embodiments of the present invention is shown. FIG. 4B describes obtaining a second video walkthrough or 360 degree photos of building locations 124 as shown in FIG. 1 while referencing the same floor plan of the building 104 as shown in FIG. 4A.

After the first 360 degree photos (1A-8A) have been extracted by the image processing device 116 from the first video of building walkthrough 120, a second walkthrough is performed at a later time. The second walkthrough is performed in one of two ways, possibly depending on the type of 360 degree image capture device 108 used. For example, if a 360 degree video camera is available (and possibly the same 360 degree image capture device 108 as used to capture the video taken at the earlier time 112A), a second video of the building 104 may be captured. Also, if a 360 degree photo camera is available instead, it may be used to capture selected photos in proximity to one or more locations corresponding to first 360 degree photos.

A person or vehicle proceeds along a path of second 360 degree video or photo capture 420. The same types of vehicles and remote use capabilities applied to the video at the earlier time 112A apply equally to second video or photos as the later time 112B. The path 420 may be the same or different than the first 360 degree image capture device path 404. However, if the paths 420, 404 are different, there must at least be path intersection at important locations. For example, if it were determined that second 360 degree photos were required at the same building locations as first 360 degree photos 1A, 3A, 5A, 6A, and 8A (thus resulting in second 360 degree photos 1B, 3B, 5B, 6B, and 8B), a person or vehicle might travel along the path 420 to obtain the needed photos at second 360 degree photo locations within the building 424. The 360 degree image capture device 108 used may be recording either a 360 degree video or 360 degree photos.

Because of the need to compare first 360 degree photos to second 360 degree photos, it is important to capture the second 360 degree photos within proximity to the first 360 degree photos 428. The reason for this is to maximize the amount of common building construction in view and common to both images. Additionally, annotation may specify a small detail in the first 360 degree photos that may be only visible when the second 360 degree photos are within a certain proximity to the first 360 degree photos 428. Thus proximity may in some embodiments be situationally dependent. In one embodiment, proximity may mean the first and second 360 degree photos captured within 3 feet or 1 meter of each other. In another embodiment, proximity may mean that one could clearly see common major building components between the first and second sets of 360 degree photos 508, 516, such that one could tell an object was in the same location.

At the end of the walkthrough shown in FIG. 4B, the 360 degree image capture device 108 transfers the second video walkthrough or 360 degree photos of building locations 124 to the image processing system 116, and the image processing device 116 now has the desired first and second 360 degree photos to compare. In one embodiment, the 360 degree image capture device 108 has the ability to annotate the second 360 degree photos or video, and transfer the annotated second 360 degree photos or video to the image processing device 116. In another embodiment, the image processing device 116 adds annotation to the second video walkthrough or 360 degree photos of building locations 124.

Referring now to FIG. 5, a diagram illustrating extracted first and second 360 degree photos in accordance with embodiments of the present invention is shown. FIG. 5 illustrates an editing process of the first (FIG. 4A) and second (FIG. 4B) building walkthroughs in order to obtain first and second 360 degree photos, respectively.

As described with reference to FIG. 4A, the image processing device 116 receives the video taken at an earlier time 112A from the 360 degree image capture device 108. Based on the first 360 degree photos discrete intervals 370 in metadata 212, the image processing system 108 determines how often (time 372, distance 374, or video frames 376) to extract photos from the video 112A. Beginning at the start of the video 112A (corresponding to the start of path 404), the image processing device 116 extracts first 360 degree photos 408 according to the specified intervals 370. In the example of FIG. 4A, eight first 360 degree photos are extracted (1A-8A) at locations 408.

A user of image processing device 116 reviews the first 360 degree photos, and in some embodiments eliminates one or more from further consideration. For example, a user may eliminate photo 2A as being blurry, photo 4A as being in an unimportant area (such as not under construction or already checked), and photo 7A as being too dark (poorly lit area unlikely to provide useful information). This then leave five photos (1A, 3A, 5A, 6A, and 8A) as first 360 degree photos 508.

Of the first 360 degree photos 508, the user decides to add annotation to three—photos 1A (now 1A′), 5A (now 5A′), and 6A (now 6A′). For example, the annotation may include a construction symbol at a coordinate in photo 1A′, an overall annotation describing the state of construction in photo 5A′, and an audio message at a coordinate in photo 6A′. The types of content and annotation may be independent or related between each of the annotated first 360 degree photos 512. Any number of first 360 degree photos 508 may be annotated, whether none, some, or all. The annotation accompanies a corresponding first 360 degree photo 508, and may be represented as a separate layer within a file from the first 360 degree photo 508 itself.

Following the video taken at the earlier time 112A, it is desired to obtain additional photos (second 360 degree photos 516) to compare progress to the first 360 degree photos 508 or annotated first 360 degree photos 512. The time between obtaining the first 360 degree photos 508 or annotated first 360 degree photos 512 and the second 360 degree photos 516 may be predetermined such as based on a construction schedule 340, or not. However, in most embodiments the time at which the second 360 degree photos 516 are obtained is based on an expectation of some form of progress from the construction state reflected in the first 360 degree photos 508 or annotated first 360 degree photos 512.

In one embodiment, the second 360 degree photos 516 are obtained from a second video taken at a later time 112B. This is explained with reference to FIG. 4B and follows a similar extraction/selection process as the first 360 degree photos 508. In some embodiments there may be no annotation added to the second 360 degree photos 516, especially if further 360 degree photos of the building 104 are not required. However, for embodiments where either further 360 degree photos of the building 104 are required (for one or more next construction phases, for example) or it is desirable to have an annotated photo record of continuing progress, annotation may be added to the second 360 degree photos 516 in similar fashion as annotated first 360 degree photos 512.

In one embodiment there may be fewer second 360 degree photos than first 360 degree photos such as when first 360 degree photos 508, 512 reflect completed construction for an area of the building 104. In other embodiments there may be a same number of second 360 degree photos as first 360 degree photos. In yet other embodiments there may be more second 360 degree photos than first 360 degree photos such as starting construction in a new area of the building reflected by one or more second 360 degree photos 516.

Referring now to FIG. 6, a diagram illustrating 360 degree camera orientation in accordance with embodiments of the present invention is shown. FIG. 6 illustrates various camera orientations relative to x, y, and z dimensions. The x dimension may be viewed as left 616 to right 612. The y dimension may be viewed as up 620 to down 624. The z dimension may be viewed as front 604 to rear 608. Each dimension may also have a rotation about one of the three axes. A rotation around the x dimension (left-right axis) is pitch 632, and from a camera position at the center of the diagram is viewed as up or down motion. A rotation around the y dimension (up-down axis) is yaw 636, and from a camera position at the center of the diagram is viewed as left or right motion. A rotation around the z dimension (front-rear axis) is roll 628, and from a camera position at the center of the diagram is viewed as tilting left or right motion.

When specifying a specific 360 degree image capture device 108 view, it is important to specify several parameters. First, 360 degree photo locations 408, 424 specify a specific position in relation to the building 104. Next, an orientation of roll 628, pitch 632, and yaw 636 values yields a specific pointing direction in 3-dimensional space. As long as the 360 degree image capture device 108 is maintained in an untilted (no roll 628) attitude, only pitch 632 and yaw 636 values need to be specified. In some embodiments, a gyroscopic device may provide any required roll 628, pitch 632, or yaw 636 values. Such a gyroscopic device may be included as part of, or separate from, the 360 degree image capture device 108.

One other parameter may need to be provided in order to fully specify a camera view: field of view. The 360 degree image capture device 108 has a lens which may or may not be adjustable. The field of view is a standard measurement (i.e. a 360 field of view of a 360 degree camera, a 90 degree field of view from a standard camera, etc.).

Referring now to FIG. 7A, a diagram illustrating a first 360 degree photo 508 without annotation in accordance with embodiments of the present invention is shown. FIG. 7A also shows a first 360 degree photo 508 before annotation is added.

The first 360 degree photo 508 reflects a view from a position associated with building 104 and with a particular orientation. In the example shown in FIG. 7A, the first 360 degree photo 508 reflects a position and orientation corresponding to photo 1A of FIG. 4A—generally in the doorway of building 104 and looking into the building 104 interior. The illustrated first 360 degree photo 508 reflects a state of construction generally reflecting a pre-drywall phase 356. Sheets of stacked drywall material are visible in the lower right corner, windows at the far end, a mixer and stacked boxes on the right side, an A-frame support on the left side, and a door at the lower left corner.

Referring now to FIG. 7B, a diagram illustrating an annotated first 360 degree photo 512 in accordance with embodiments of the present invention is shown. FIG. 7B illustrates the first 360 degree image 508 of FIG. 1, after four annotations 712 have been added—signified by the letters “A”, “B”, “C”, and “D” within triangles. The symbology shown is simply an example of a type of annotation, and any other form of annotation may be represented in annotated first 360 degree photos 512.

Annotations 712 may be any form of text or graphics added to the first 360 degree photo 508 in order to provide more information. For example, annotation 712 may include relevant text such as “pipe location too far left” or “add additional support here”, in order to describe a current state of construction and possibly provide instruction to others. Annotation 712 may also include descriptive graphics such as a directional arrow or a circled item within the annotated first 360 degree photo 512. Annotation 712 may also include a combination of any text or graphics. Annotation 712 may also specify one or more colors the annotation 712 will appear as in the annotated first 360 degree photo 512, or a line width for the annotation 712. Different colors and line widths may be used for different annotations 712. Annotation 712 may also include an identifier (alphanumeric or symbol) that references a comment/description in a row of a table, for example. For example, metadata 212 may include a table that cross references an identifier in the annotated first 360 degree photo 512 (“B”, for example) with an annotation ID 324 and corresponding coordinate 326.

Each annotation 712 present in the annotated first 360 degree image 512 may have a corresponding selected coordinate 716. Thus, for annotation “B” 712, there is a corresponding selected coordinate 716, for annotation “B” 712, there is a corresponding selected coordinate 716B, for annotation “C” 712, there is a corresponding selected coordinate 716C, and for annotation “D” 712, there is a corresponding selected coordinate 716D. Each selected coordinate 716 may include a pitch 632 and a yaw 636 value. Pitch values 632 range from a minimum of −90 degrees to a maximum of +90 degrees. Yaw values 636 range from a minimum of 0 degrees to a maximum of 360 degrees (where, obviously, 0 degrees is the same view as 360 degrees). Therefore, for each annotation 712 present in an annotated first 360 degree image 512, there is corresponding pitch 632 and yaw 636 values, assuming that the camera or image capture device 108 is not rolled 628, as previously described. For illustration purposes, FIG. 7B only shows approximately 120 degrees of yaw 636, instead of the full 360 degrees of the annotated first 360 degree image 512.

At least one annotation 712 must be included with the annotated first 360 degree image 512, and may be included within all boundaries of the first 360 degree photo 508. However, annotations 712 that are not tied to coordinates 716, such as global annotations reflecting the state of the displayed photo 508, may not be included within the boundaries of the first 360 degree photo 508. Such annotations may be displayed on a separate layer that always remains on top of the photo 512, and/or is included within metadata 212 that is associated with the photo/frame or range of frames. For example, a first 360 degree photo 512 may be labeled “pre-drywall phase”, or “pre-concrete pour” phase, which is easy to determine either by a human with experience, or a trained machine using machine learning and computer vision. This is because the photo as a whole can have a label based on a stage of construction. Annotation(s) 712, when added to the first 360 degree photo 508, create an annotated first 360 degree image 512.

In one embodiment, an application 216 may, using computer vision and machine learning technologies, determine a construction phase for each first or second 360 degree photo 508, 512, 516. If the determined construction phase for a newly analyzed photo does not match a construction schedule 340, or a stored deadline has not been met, the application 216 may highlight one or more parts of a photo 508, 512, 516 or add annotation 712 noting a delay in the project. In another embodiment, predetermined annotation 712 may cause the application 216 to determine a construction phase from a photo 508, 512, 516, and either provide a notification or add a new annotation 712 if the project is not on schedule.

In one embodiment, annotations 712 are added to the first 360 degree photo 508 by users of the 360 degree image capture device 108, with the device 108. However, in some cases the 360 degree image capture device 108 may lack an add annotation 712 capability, and only be capable of capturing, storing, or transferring first or second 360 degree videos or photos 112A, 112B, 120, or 124. In such cases, it may be necessary to transfer the first or second 360 degree videos or photos 120, 124 to the image processing device 116, where one or more users may add one or more annotations 712 to create the annotated first 360 degree photos 508 (or annotated second 360 degree photos).

Referring now to FIG. 8, a diagram illustrating a second 360 degree photo 516 in accordance with embodiments of the present invention is shown. Second 360 degree photos 516 are taken at a later time than first 360 degree photos 508, and may be expected to reflect construction progress since a time when the first 360 degree photos 508 were obtained.

In the example shown in FIG. 8, the second 360 degree photo 1B 804 reflects a position and orientation corresponding to photo 1B of FIG. 4B—generally in the doorway of building 104 and looking into the building 104 interior. This photo is taken from generally the same position and viewing direction as photo 1A of FIG. 7A. The illustrated second 360 degree photo 1B 804 reflects a state of construction generally reflecting a post-drywall phase 358. The sheets of stacked drywall material are no longer visible in the lower right corner, and have been installed to the ceiling and walls compared to FIG. 7A. Other changes may be seen to other parts of the second 360 degree photo 1B 804.

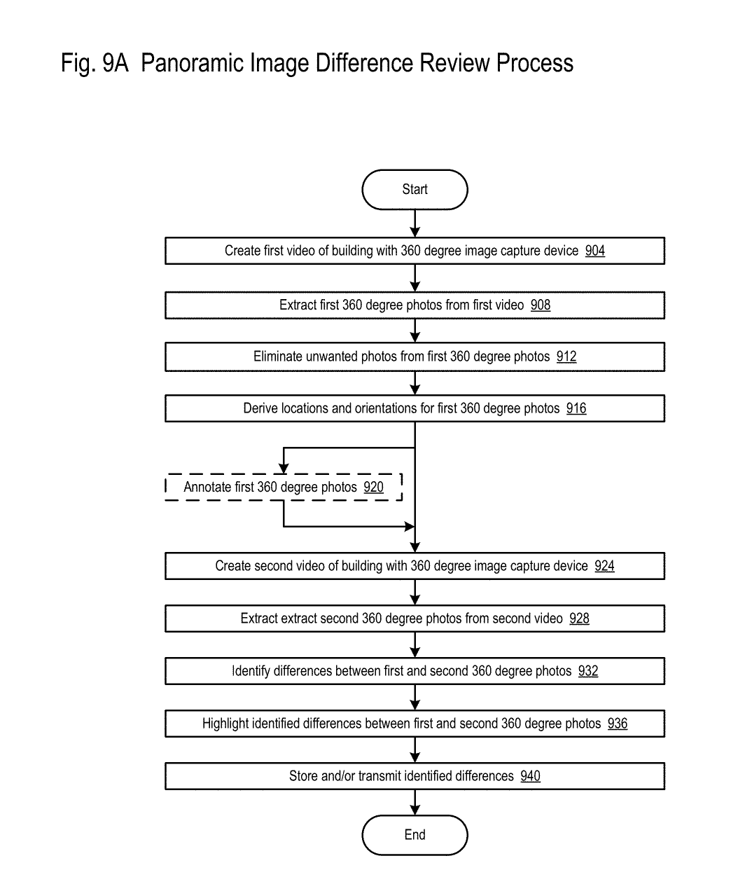

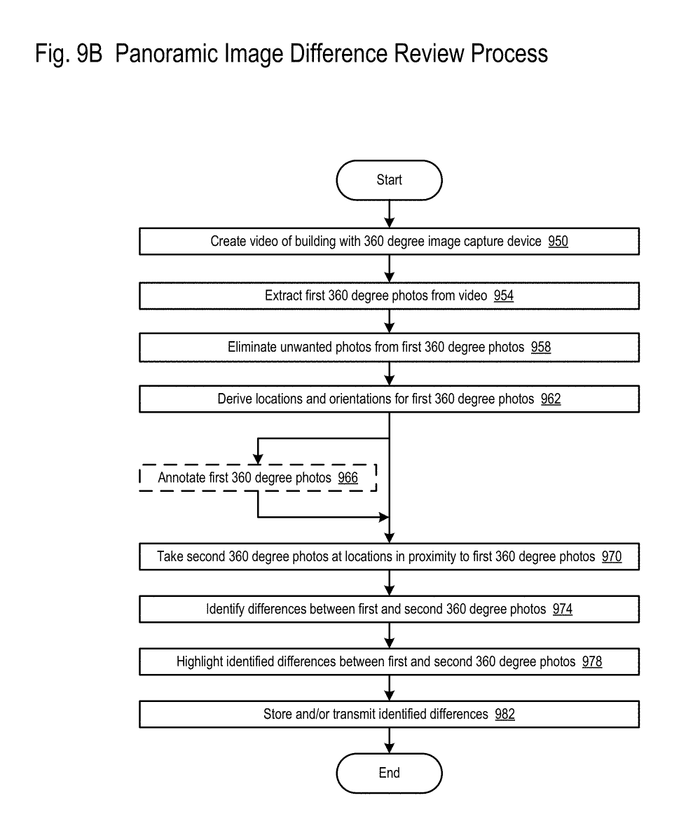

Referring now to FIG. 9A, a flowchart illustrating a panoramic image difference review process in accordance with a first embodiment of the present invention is shown. FIG. 9A illustrates interactions between one or more 360 degree image capture devices 108 and an image processing device 116. Flow begins at block 904.

At block 904, a person or vehicle creates a first video 112A of a building 104 with a 360 degree image capture device 108. The building 104 is preferably a construction site of a building being built, remodeled, or reconstructed. The 360 degree image capture device 108 captures a video taken at an earlier, or first, time 112A. Flow proceeds to block 908.

At block 908, a user extracts first 360 degree photos 508 from the video taken at an earlier time 112A. The first 360 degree photos 508 are taken at discrete intervals from the video 112A, and include one of regular time intervals, a distance measurement, or a number of video frames. Flow proceeds to block 912.

At block 912, unwanted photos (if any) may be eliminated from the first 360 degree photos 508. The unwanted photos may be of insufficient quality or clarity, a lower priority than the other first 360 degree photos 508, or a photo 508 of a non-critical or unimportant area of the building 104. Flow proceeds to block 916.

At block 916, one or more of locations and orientations are determined for the remaining first 360 degree photos. Locations are specific locations associated with the building 104, and may be interior or exterior locations. Orientation includes a viewing direction 416 for the first 360 degree photos 508, and may be determined by a photogrammetry application 216. Flow proceeds to optional block 920 and block 924.

At optional block 920, one or more annotations 712 are added to the first 360 degree photos 508, which produced annotated first 360 degree photos 512. The one or more annotations 712 may be added within the frame of the first 360 degree photos 508 at selected coordinates 716, where each of the coordinates has a pitch 232 value and a yaw 236 value. Alternately, one or more annotations 712 may be added without regard to selected coordinates 716, and reflect the annotated first 360 degree photo 512 as a whole. Flow proceeds to block 924.

At block 924, a person or vehicle creates a second video taken at a later time 112B of the building 104 with a 360 degree image capture device 108. The 360 degree image capture device 108 used to create the second video 112B may be the same or different device used to create the first video 112A in block 904. Flow proceeds to block 928.

At block 928, a user extracts second 360 degree photos 516 from the second video taken at a later time 112B. The second video includes one or more locations in proximity to those in the first video 428 so that one or more second 360 degree photos 516 correspond to one or more first 360 degree photos 508, 512. Flow proceeds to block 932.

At block 932, a user of the image processing device 116 identifies one or more differences between the first 360 degree photos 508, 512 and the second 360 degree photos 516. The differences may be noted by performing an overall view of each of the first 360 degree photos 508, 512 and the second 360 degree photos 516, or by reviewing annotation on first 360 degree photos 512 and comparing differences referenced by the annotation to the second 360 degree photos 516. Flow proceeds to block 936.

At block 936, the image processing device 116 highlights differences between the first 360 degree photos 508, 512 and the second 360 degree photos 516. The highlights may be actual highlights applied to one or more of first 360 degree photos 508, 512 and the second 360 degree photos 516, one or more overlays applied to the first 360 degree photos 508, 512 and the second 360 degree photos 516, new or different colors applied to the first 360 degree photos 508, 512 and the second 360 degree photos 516, or any other technique for annunciation of the differences. The highlights may also include alphanumeric text entries into a list or table that describes the differences or the entries.

Highlighting differences between the first 360 degree photos 508, 512 and the second 360 degree photos 516 may also include one or more of modifying a schedule 340 to signify differences satisfying the annotation 712 and one or more of storing and transferring a notification to address the annotation in response to differences not satisfying the annotation. Flow proceeds to block 940.

At block 940, the image processing device 116 stores and/or transmits the identified differences. In one embodiment, the image processing device 116 stores the identified differences to a storage medium coupled to or associated with the image processing device 116. In another embodiment, the image processing device 116 transfers the identified differences to a remote system or storage medium to archive the identified differences or perform additional processing. In yet another embodiment, the image processing device 116 transfers the identified differences to a 360 degree image capture device 108 associated with one or more of the first video taken at an earlier time 112A, the second video taken at a later time 112B, or the second photos taken at the later time 112B. This may allow an experienced user to use the identified differences in further captures of video or photos for the building 104. Flow ends at block 940.

Referring now to FIG. 9B, a flowchart illustrating a panoramic image difference review process in accordance with a second embodiment of the present invention is shown. FIG. 9B also illustrates interactions between one or more 360 degree image capture devices 108 and an image processing device 116. Flow begins at block 950.

At block 950, a person or vehicle creates a first video of a building 104 with a 360 degree image capture device 108. The building 104 is preferably a construction site of a building being built, remodeled, or reconstructed. The 360 degree image capture device 108 captures a video taken at an earlier, or first, time 112A. Flow proceeds to block 954.

At block 954, a user extracts first 360 degree photos 508 from the video taken at an earlier time 112A. The first 360 degree photos 508 are taken at discrete intervals 370 from the video 112A, and include one of regular time intervals, a distance measurement, or a number of video frames. Flow proceeds to block 958.

At block 958, unwanted photos (if any) may be eliminated from the first 360 degree photos 508. The unwanted photos may be of insufficient quality or clarity, a lower priority than the other first 360 degree photos 508, or a photo 508 of a non-critical or unimportant area of the building 104. Flow proceeds to block 962.

At block 962, one or more of locations and orientations are determined for the remaining first 360 degree photos. Locations are specific locations associated with the building 104, and may be interior or exterior locations. Orientation includes a viewing direction 416 for the first 360 degree photos 508. Photogrammetry applications 216 may be used to determine item locations and orientations within 360 degree photos. Flow proceeds to optional block 966 and block 970.

At optional block 966, one or more annotations 712 are added to the first 360 degree photos 508, which produced annotated first 360 degree photos 512. The one or more annotations 712 may be added within the frame of the first 360 degree photos 508 at selected coordinates 716, where each of the coordinates has a pitch 232 value and a yaw 236 value. Alternately, one or more annotations 712 may be added without regard to selected coordinates 716, and reflect the annotated first 360 degree photo 512 as a whole. Flow proceeds to block 970.

At block 970, a person or vehicle takes second 360 degree photos 516, in lieu of a second video, of the building 104 with a 360 degree image capture device 108. The second 360 degree photos 516 are taken in proximity to the first 360 degree photos 508. The 360 degree image capture device 108 used to create the second 360 degree photos 516 may be the same or different device used to create the first video in block 904. Flow proceeds to block 974.

At block 974, a user of the image processing device 116 identifies one or more differences between the first 360 degree photos 508, 512 and the second 360 degree photos 516. The differences may be noted by performing an overall view of each of the first 360 degree photos 508, 512 and the second 360 degree photos 516, or by reviewing annotation on first 360 degree photos 512 and comparing differences referenced by the annotation to the second 360 degree photos 516. Flow proceeds to block 978.

At block 978, the image processing device 116 highlights differences between the first 360 degree photos 508, 512 and the second 360 degree photos 516. The highlights may be actual highlights applied to one or more of the first 360 degree photos 508, 512 and the second 360 degree photos 516, one or more overlays applied to the first 360 degree photos 508, 512 and the second 360 degree photos 516, new or different colors applied to the first 360 degree photos 508, 512 and the second 360 degree photos 516, or any other technique for annunciation of the differences. The highlights may also include alphanumeric text entries into a list or table that describes the differences or the entries.

Highlighting differences between the first 360 degree photos 508, 512 and the second 360 degree photos 516 may also include one or more of modifying a schedule 340 to signify differences satisfying the annotation 712 and one or more of storing and transferring a notification to address the annotation in response to differences not satisfying the annotation. Flow proceeds to block 982.

At block 982, the image processing device 116 stores and/or transmits the identified differences. In one embodiment, the image processing device 116 stores the identified differences to a storage medium coupled to or associated with the image processing device 116. In another embodiment, the image processing device 116 transfers the identified differences to a remote system or storage medium to archive the identified differences or perform additional processing. In yet another embodiment, the image processing device 116 transfers the identified differences to a 360 degree image capture device 108 associated with one or more of the first video taken at an earlier time 112A, the second video taken at a later time 112B, or the second photos taken at the later time 112B. This may allow an experienced user to use the identified differences in further captures of video or photos for the building 104. Flow ends at block 982.

The various views and illustration of components provided in the figures are representative of exemplary systems, environments, and methodologies for performing novel aspects of the disclosure. For example, those skilled in the art will understand and appreciate that a component could alternatively be represented as a group of interrelated sub-components attached through various temporarily or permanently configured means. Moreover, not all components illustrated herein may be required for a novel embodiment, in some components illustrated may be present while others are not.

The descriptions and figures included herein depict specific embodiments to teach those skilled in the art how to make and use the best option. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

Finally, those skilled in the art should appreciate that they can readily use the disclosed conception and specific embodiments as a basis for designing or modifying other structures for carrying out the same purposes of the present invention without departing from the spirit and scope of the invention as defined by the appended claims.

We calim:

1. A method comprising:
creating, with a first 360 degree image capture device, a video while moving along a path within a building at a first time;
extracting a plurality of first 360 degree photos from the video;
deriving one or more of locations and orientations within the building for each of the plurality of first 360 degree photos;
obtaining a plurality of second 360 degree photos at one or more positions in proximity to one or more points along the path at a second time later than the first time, the plurality of second 360 degree photos having one or more common locations and orientations within the building as the plurality of first 360 degree photos; and
identifying differences between the first plurality of 360 degree photos and the second plurality of 360 degree photos.

2. The method of claim 1, wherein extracting the plurality of first 360 degree photos from the video comprising:
obtaining the plurality of first 360 degree photos at discrete intervals from the video, the discrete intervals comprising one of regular time intervals, a distance measurement, or a number of video frames.

3. The method of claim 1, wherein deriving orientations within the building for each of the plurality of first 360 degree photos comprising:
determining a common viewing directions based on an azimuth for the plurality of first 360 degree photos.

4. The method of claim 1, wherein in response to extracting the plurality of first 360 degree photos from the video, the method further comprising:
annotating one or more of the plurality of first 360 degree photos, annotation comprising one or more of text, one or more symbols, or audio, the annotation specifying one or more of an action, a construction state, a construction error, a date, a time, or a reminder.

5. The method of claim 4, wherein identifying differences between the first plurality of 360 degree photos and the second plurality of 360 degree photos comprising one or more of:
selecting second 360 degree photos corresponding to first 360 degree photos;
identifying differences between the first and second 360 degree photos; and
one or more of:
highlighting one or more of the first and second 360 degree photos at one or more locations of identified differences; and
one or more of storing and transmitting one or more identified differences; or
selecting second 360 degree photos corresponding to annotated first 360 degree photos;
identifying differences between the annotated first 360 degree photos and the second 360 degree photos; and
comparing the differences to the annotation; or
selecting second 360 degree photos corresponding to annotated first 360 degree photos, one or more annotated first 360 degree photos comprising annotation at one or more selected coordinates;
reviewing the selected second 360 degree photos at the one or more selected coordinates corresponding to the annotated first 360 degree photos;
identifying differences between the first and second 360 degree photos at the one or more selected coordinates; and
comparing the differences to the annotation.

6. The method of claim 5, wherein in response to one of identifying differences between the first and second 360 degree photos and comparing the differences to the annotation, the method further comprising one or more of:
modifying a schedule to signify differences satisfying the annotation; and
one or more of storing and transferring a notification to address the annotation in response to differences not satisfying the annotation.

7. The method of claim 6, wherein obtaining the plurality of second 360 degree photos comprising one of:
creating, with a second 360 degree image capture device, a video while in proximity to-one or more points of the path at a second time later than the first time; and
extracting the plurality of second 360 degree photos from the video; or
creating, with the second 360 degree image capture device, the plurality of second 360 degree photos in proximity to camera positions for corresponding first 360 degree photos-at the second time,
wherein the second 360 degree image capture device may be the same or different than the first 360 degree image capture device.

8. A system, which comprises:
a first 360 degree image capture device, configured to create a video while the first 360 degree image capture device moves along a path within a building at a first time;
an image processing device, which comprises:
a memory, which comprises:
a 360 degree photo viewer application; and
a processor, coupled to the memory, configured to:
extract a plurality of first 360 degree photos from the video;
derive one or more of locations and orientations within the building for each of the plurality of first 360 degree photos;
obtain a plurality of second 360 degree photos at one or more positions in proximity to one or more points along the path at a second time later than the first time, the plurality of second 360 degree photos has one or more common locations and orientations within the building as the plurality of first 360 degree photos;
display one or more first and second 360 degree photos in the 360 degree photo viewer application, the one or more second 360 degree photos corresponds to one or more first 360 degree photos taken from common locations within the building.

9. The system of claim 8, wherein the processor extracts the plurality of first 360 degree photos from the video comprises the processor obtains the plurality of first 360 degree photos at discrete intervals from the video, wherein the discrete intervals comprises one of regular time intervals, a distance measurement, or a number of video frames.

10. The system of claim 8, wherein the processor derives orientations within the building for each of the plurality of first 360 degree photos comprises the processor determines a common viewing direction based on an azimuth for the plurality of first 360 degree photos.

11. The system of claim 8, wherein in response to the processor extracts the plurality of first 360 degree photos from the video, the processor adds annotation to one or more of the plurality of first 360 degree photos, wherein the annotation comprises one or more of text, one or more symbols, or audio and specifying one or more of an action, a construction state, a construction error, a date, a time, or a reminder.

12. The system of claim 11, wherein the processor identifies differences between the first plurality of 360 degree photos and the second plurality of 360 degree photos, which comprises one or more of the processor:
selects second 360 degree photos corresponding to first 360 degree photos;
identifies differences between the first and second 360 degree photos; and
one or more of:
highlights one or more of the first and second 360 degree photos at one or more locations of identified differences; and
one or more of stores and transmits one or more identified differences; or
selects second 360 degree photos corresponding to annotated first 360 degree photos;
identifies differences between the annotated first 360 degree photos and the second 360 degree photos; and
compares the differences to the annotation; or
selects second 360 degree photos corresponding to annotated first 360 degree photos, one or more annotated first 360 degree photos comprising annotation at one or more selected coordinates;
reviews the selected second 360 degree photos at the one or more selected coordinates corresponding to the annotated first 360 degree photos;
identifies differences between the first and second 360 degree photos at the one or more selected coordinates; and
compares the differences to the annotation.

13. The system of claim 12, wherein in response to one of the processor identifies differences between the first and second 360 degree photos and compares the differences to the annotation, one or more of the processor modifies a schedule to signify differences that satisfies the annotation and one or more of stores and transfers a notification to address the annotation in response to differences that do not satisfy the annotation.

14. The system of claim 13, wherein the processor obtains the plurality of second 360 degree photos comprises one of the processor:
receives, from a second 360 degree image capture device, a video while in proximity to one or more points of the path at a second time later than the first time; and
extracts the plurality of second 360 degree photos from the video; or
creates, with the second 360 degree image capture device, the plurality of second 360 degree photos in proximity to camera positions for corresponding first 360 degree photos-at the second time,
wherein the second 360 degree image capture device may be the same or different than the first 360 degree image capture device.

15. A non-transitory computer readable storage medium configured to store instructions that when executed cause a processor to perform:
creating, with a first 360 degree image capture device, a video while moving along a path within a building at a first time;
extracting a plurality of first 360 degree photos from the video;
deriving one or more of locations and orientations within the building for each of the plurality of first 360 degree photos;
obtaining a plurality of second 360 degree photos at one or more positions in proximity to one or more points along the path at a second time later than the first time, the plurality of second 360 degree photos having one or more common locations and orientations within the building as the plurality of first 360 degree photos; and
identifying differences between the first plurality of 360 degree photos and the second plurality of 360 degree photos.

16. The non-transitory computer readable storage medium of claim 15,
wherein extracting the plurality of first 360 degree photos from the video comprising:
obtaining the plurality of first 360 degree photos at discrete intervals from the video, the discrete intervals comprising one of regular time intervals, a distance measurement, or a number of video frames,
wherein deriving orientations within the building for each of the plurality of first 360 degree photos comprising:
determining a common viewing direction based on an azimuth for the plurality of first 360 degree photos.

17. The non-transitory computer readable storage medium of claim 15, wherein in response to extracting the plurality of first 360 degree photos from the video, the processor further configured to perform:
annotating one or more of the plurality of first 360 degree photos, annotation comprising one or more of text, one or more symbols, or audio and specifying one or more of an action, a construction state, a construction error, a date, a time, or a reminder.

18. The non-transitory computer readable storage medium of claim 15, wherein identifying differences between the first plurality of 360 degree photos and the second plurality of 360 degree photos comprising the processor configured to perform one or more of:
selecting second 360 degree photos corresponding to first 360 degree photos;
identifying differences between the first and second 360 degree photos; and
one or more of:
highlighting one or more of the first and second 360 degree photos at one or more locations of identified differences; and
one or more of storing and transmitting one or more identified differences; or
selecting second 360 degree photos corresponding to annotated first 360 degree photos;
identifying differences between the annotated first 360 degree photos and the second 360 degree photos; and
comparing the differences to the annotation; or
selecting second 360 degree photos corresponding to annotated first 360 degree photos, one or more annotated first 360 degree photos comprising annotation at one or more selected coordinates;
reviewing the selected second 360 degree photos at the one or more selected coordinates corresponding to the annotated first 360 degree photos;
identifying differences between the first and second 360 degree photos at the one or more selected coordinates; and
comparing the differences to the annotation.

19. The non-transitory computer readable storage medium of claim 18, wherein in response to one of identifying differences between the first and second 360 degree photos and comparing the differences to the annotation, the processor configured to perform one or more of:
modifying a schedule to signify differences satisfying the annotation; and
one or more of storing and transferring a notification to address the annotation in response to differences not satisfying the annotation.

20. The non-transitory computer readable storage medium of claim 19, wherein obtaining the plurality of second 360 degree photos comprising the processor configured to perform one of:
creating, with a second 360 degree image capture device, a video while in proximity to-one or more points of the path at a second time later than the first time; and
extracting the plurality of second 360 degree photos from the video; or
creating, with the second 360 degree image capture device, the plurality of second 360 degree photos in proximity to camera positions for corresponding first 360 degree photos-at the second time,
wherein the second 360 degree image capture device may be the same or different than the first 360 degree image capture device.
